(19) United States
(12) Patent Application Publication
(10) Pub. No.: US 2024/0395440 A1
(43) Pub. Date: Nov. 28, 2024

(54) CONDUCTOR INSULATION SYSTEM WITH NANOPARTICLE COMPOSITE LAYER

(71) Applicant: Baker Hughes Oilfield Operations LLC, Houston, TX (US)

(72) Inventors: Dennis Matuszak, Broken Arrow, OK (US); Michael Cai, Broken Arrow, OK (US); David Livingston, Claremore, OK (US)

(73) Assignee: Baker Hughes Oilfield Operations LLC, Houston, TX (US)

(21) Appl. No.: 18/200,465

(22) Filed: May 22, 2023

(51) Int. Cl. H01B 7/04; B32B 18/00; B32B 27/28; B32B 27/32; H01B 7/02

(52) U.S. Cl. CPC H01B 7/046; B32B 18/00; B32B 27/281; B32B 27/288; B32B 27/322; H01B 7/0225; B32B 2264/108; B32B 2264/203; B32B 2307/206; B32B 2457/04

(57) ABSTRACT

Electric submersible pumping systems are exposed to harsh chemicals in the downhole environment. Conductors used in the electric submersible pumping system must be shielded against these chemicals. To improve the resistance of conductors to hydrogen sulfide and other aggressive chemicals, an improved insulation system includes an interior layer applied to the conductor, a first outer layer, and an intermediate layer between the interior layer and the first outer layer. The intermediate layer can be a nano-composite layer that includes a mixture of nanoparticles in a polyether ether ketone (PEEK) polymer.

### FIELD OF THE INVENTION

The present invention relates generally to electric submersible pumping systems and more particularly to the insulation of electric conductors used in downhole electric submersible pumping systems.

### BACKGROUND

Submersible pumping systems are often deployed into wells to recover petroleum fluids from subterranean reservoirs. Typically, a submersible pumping system includes a number of components, including an electric motor coupled to one or more high performance pump assemblies. Production tubing is connected to the pump assemblies to deliver the petroleum fluids from the subterranean reservoir to a storage facility on the surface.

The motor is typically an oil-filled, high capacity electric motor that can vary in length from a few feet to nearly one hundred feet, and may be rated up to hundreds of horsepower. Typically, electricity is generated on the surface and supplied to the motor through a heavy-duty power cable. The power cable typically includes several separate conductors that are individually insulated within the power cable. Power cables are often constructed in round or flat configurations.

In many applications, power is conducted from the power cable to the motor via a “motor lead cable.” The motor lead cable typically includes one or more “leads” that are configured for connection to a mating receptacle on the motor. The leads from the motor lead cable are often retained within a motor-connector that is commonly referred to as a “pothead.” The pothead relieves the stress or strain realized between the motor and the leads from the motor lead cable. Motor lead cable is often constructed in a “flat” configuration for use in the limited space between downhole equipment and the well casing.

Because the power and motor lead cables are positioned in the annulus between the production string and well casing, these cables must be designed to withstand the inhospitable downhole environment. Prior art cables often fail over time as corrosive well fluids degrade the various layers of insulation placed around the electrical conductors. Without sufficient insulation, the high-capacity power and motor lead cables become susceptible to electrical malfunctions that cause irreparable damage to the cable and downhole equipment.

Power and motor lead cables typically include a conductor, insulation surrounding the conductor, a lead jacket encasing the insulator, and a durable external armor that surrounds the jacket. Although covered by several layers of protection, the insulation remains a common source of failure in power and motor lead cables. In the past, manufacturers have used EPDM rubber, polypropylene or polyethylene as the dielectric insulation layer that surrounds the conductive material.

In certain applications, the presence of hydrogen sulfide (H₂S) in the wellbore can accelerate corrosion and other attacks on the conductor (carcass) of the cable. In the past, extruded lead has been used as a barrier to protect the copper conductor from H₂S attack. Lead can be toxic to humans and animals and carries certain health and safety concerns. Additionally, lead is heavy and increases the costs associated with manufacturing, packaging, shipping, and handling. Furthermore, lead is a soft metal that can be mechanically damaged, which may compromise its ability to provide a barrier function. Accordingly, there is a need for an improved cable design for use in power and motor lead cables that provides adequate resistance from H₂S and other corrosive compounds in downhole environments. It is to these and other deficiencies in the prior art that exemplary embodiments of the present invention are directed.

### SUMMARY OF THE INVENTION

In some embodiments, the present disclosure is directed to an improved insulation system for a conductor useable in a downhole environment. The insulation system includes an interior layer applied to the conductor, a first outer layer, and a nano-composite intermediate layer between the interior layer and the first outer layer. In other embodiments, the nano-composite layer is formed around the outside of the first outer layer. The nano-composite layer can include a mixture of nanoparticles in a polyether ether ketone (PEEK) polymer.

In other embodiments, the present disclosure is directed to a multilayered insulation system for insulating a conductor useful in an electric submersible pumping system. In these embodiments, the insulation system has an interior metal layer surrounding the conductor, a first outer polymer layer, an intermediate nanoparticle layer between the interior layer and the first outer layer, and a second outer layer between the first outer layer and the nano-composite layer intermediate layer. The intermediate layer comprises a nano-composite layer fabricated from a blend of nanoparticles in a polymer, and the second outer layer comprises a polyether ether ketone (PEEK) polymer.

In yet other embodiments, the present disclosure is directed at a multilayered insulation system for insulating a conductor useful in an electric submersible pumping system. Here, the insulation system includes an interior metal layer surrounding the conductor, a first outer polymer layer, and an intermediate nano-composite layer between the interior layer and the first outer layer. The intermediate layer includes a nano-composite layer fabricated from a blend of nanoparticles in a polymer. The insulation system also includes a second outer polymer layer between the first outer layer and the nano-composite layer intermediate layer and a protective film layer between the interior layer and the nano-composite layer intermediate layer. The second outer polymer layer is manufactured from a polyether ether ketone (PEEK) polymer.

### BRIEF DESCRIPTION OF THE DRAWINGS

FIG. 1 is a side view of a downhole pumping system constructed in accordance with an embodiment of the present invention.

FIG. 2 is a perspective view of the power cable of the downhole pumping system of FIG. 1.

FIG. 3 is a perspective view of the motor lead cable of the downhole pumping system of FIG. 1.

FIG. 4 is a cross-sectional view of the conductor and a first embodiment of the insulation system.

FIG. 5 is a cross-sectional view of the conductor and a second embodiment of the insulation system.

FIG. 6 is a cross-sectional view of the conductor and a third embodiment of the insulation system.

### WRITTEN DESCRIPTION

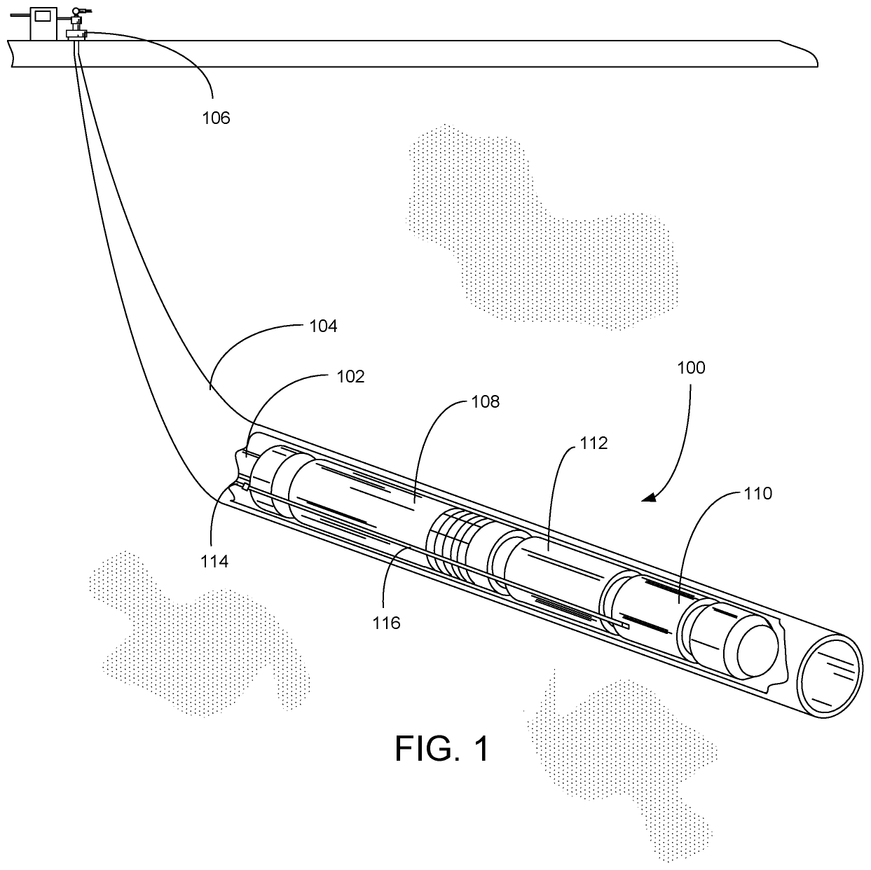

In accordance with an exemplary embodiment of the present invention, FIG. 1 shows a front perspective view of a downhole pumping system 100 attached to production tubing 102. The downhole pumping system 100 and production tubing 102 are disposed in a wellbore 104, which is drilled to produce a fluid such as water or petroleum. The downhole pumping system 100 is shown in a non-vertical well. This type of well is often referred to as a “horizontal” well. Although the downhole pumping system 100 is depicted in a horizontal well, it will be appreciated that the downhole pumping system 100 can also be used in vertical wells.

As used herein, the term “petroleum” refers broadly to all mineral hydrocarbons, such as crude oil, gas and combinations of oil and gas. The production tubing 102 connects the pumping system 100 to a wellhead 106 located on the surface. Although the pumping system 100 is primarily designed to pump petroleum products, it will be understood that the present invention can also be used to move other fluids. It will also be understood that, although each of the components of the pumping system 100 are primarily disclosed in a submersible application, some or all of these components can also be used in surface pumping operations. It will be further understood that the pumping system 100 is well-suited for use in high-temperature applications, including steam-assisted gravity drainage (SAGD) and geothermal applications, where downhole temperatures may exceed 250° C., or where the concentration of hydrogen sulfide (H₂S) gas is high.

The pumping system 100 includes a pump 108, a motor 110 and a seal section 112. The motor 110 is an electric motor that receives its power from a surface-based supply through a power cable 114 and motor lead cable 116. In many embodiments, the power cable 114 and motor lead cable 116 are each configured to supply the motor 110 with three-phase power from a surface-based variable speed (or variable frequency) drive 118. As used herein, the generic reference to “cable” refers to both the power cable 114 and the motor lead cable 116.

The motor 110 converts the electrical energy into mechanical energy, which is transmitted to the pump 108 by one or more shafts. The pump 108 then transfers a portion of this mechanical energy to fluids within the wellbore, causing the wellbore fluids to move through the production tubing 102 to the surface. In some embodiments, the pump 108 is a turbomachine that uses one or more impellers and diffusers to convert mechanical energy into pressure head. In other embodiments, the pump 108 is a progressive cavity (PC) or positive displacement pump that moves wellbore fluids with one or more screws or pistons.

The seal section 112 shields the motor 110 from mechanical thrust produced by the pump 108. The seal section 112 is also configured to prevent the introduction of contaminants from the wellbore 104 into the motor 110. Although only one pump 108, seal section 112 and motor 110 are shown, it will be understood that the downhole pumping system 100 could include additional pumps 108, seal sections 112 or motors 110.

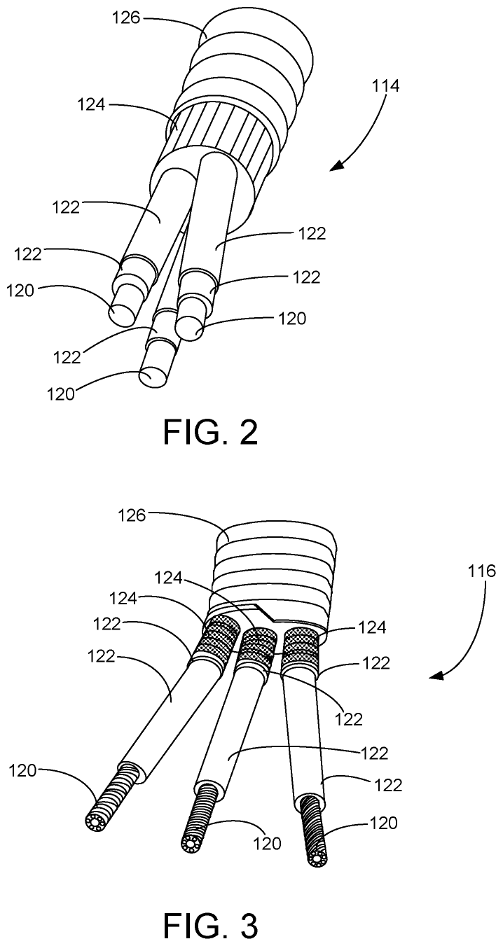

Referring now to FIGS. 2 and 3, shown therein are perspective views of a round power cable 114 and a flat motor lead cable 116, respectively. It will be understood that the geometric configuration of the power cable 114 and motor lead cable 116 can be selected on an application specific basis. Generally, flat cable configurations, as shown in FIG. 3, are used in applications where there is a limited amount of annular space around the pumping system 100 in the wellbore 104. In the exemplary embodiments depicted in FIGS. 2 and 3, the power cable 114 and motor lead cable 116 each include one or more conductors 120, an insulation system 122, a jacket 124 and external armor 126.

In exemplary embodiments, the conductors 120 are manufactured from copper and may include a solid core (as shown in FIG. 2), a stranded core, or a stranded exterior surrounding a solid core (as shown in FIG. 3). The jacket 124 is protected from external contact by the armor 126. The armor 126 can be manufactured from galvanized steel, stainless steel, Monel or other suitable metal or composite material. The insulation system 122 is configured to electrically isolate the conductors 120, while providing increased resistance to H₂S and other corrosive or oxidative compounds potentially present in the wellbore 104.

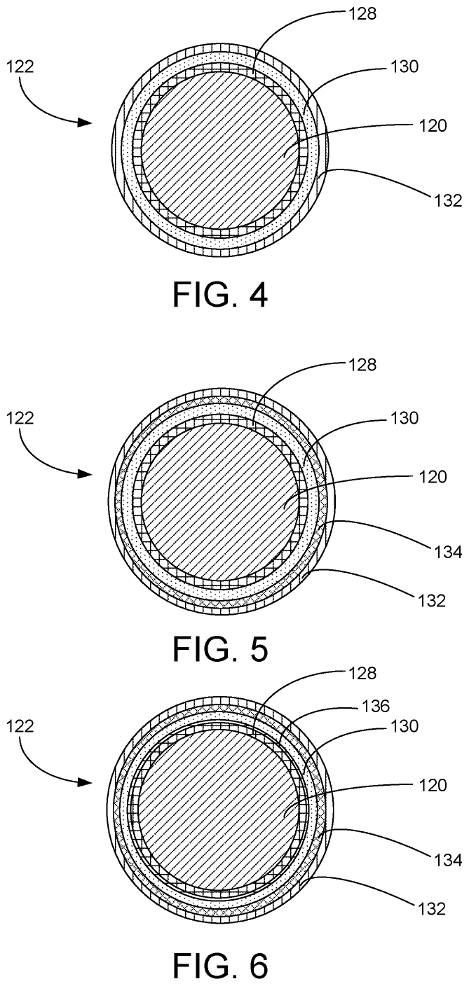

Turning to FIGS. 4-6, shown therein are cross-sectional views of the conductor 120 and various embodiments of the multilayered insulation system 122. It will be understood that the various layers of the insulation system 122 are depicted for illustrative purposes only and are not drawn to scale, particularly with respect to the conductor 120.

In the embodiment depicted in FIG. 4, the insulation system 122 includes an interior layer 128 surrounding the conductor 120, an intermediate layer 130, and a first outer layer 132. The interior layer 128 can include a layer of a metal with a thickness ranging from 0.003 to 0.02 inches. Suitable metals include lead, aluminum, zinc, nickel, and tin. In other embodiments, the interior layer 128 is a ceramic or hermetic carbon applied directly to the outer surface of the conductor 120. In some embodiments, the interior layer 128 is formulated from a combination of two or more metals or from a combination of one or more metals and a ceramic or other non-metal component. In other embodiments, the interior layer 128 includes one or more metal-organic framework (MOF) compounds.

In the embodiment depicted in FIG. 4, the intermediate layer 130 is a nano-composite material applied to the outside of the interior layer 128. The nano-composite intermediate layer 130 includes a polymer that has been blended or doped with nanoparticles. In some embodiments, the polymer is a polyether ether ketone (PEEK) polymer and the nanoparticles are graphene, high structure carbon black, metal-organic framework (MOF) compounds, or carbon nanotubes. In some embodiments, the nano-composite, intermediate layer 130 has a thickness of between about 0.02 to about 0.04 inches. In some embodiments, the nano-composite, intermediate layer 130 includes a combination of PEEK and nanoparticles with a thickness of about 0.035 inches, where the nanoparticles are blended with the polymer at a concentration ratio of between about 0.5 to about 5.0 weight/weight percent. The inclusion of the nanoparticles in the polymer provides increased resistance to H₂S and other harmful chemicals in the wellbore 104.

In the embodiment depicted in FIG. 4, the first outer layer 132 can be manufactured from a perfluoro alkoxy alkane (PFA) polymer with a thickness of about 0.035 inches. In other embodiments, the first outer layer 132 is manufactured from ethylene propylene rubber (EPR), ethylene propylene diene monomer (EPDM), or mixtures of PFA, EPR and EPDM. The first outer layer 132 can be applied to the outer surface of the nano-composite, intermediate layer 130.

Turning to FIG. 5, shown therein is an embodiment in which the insulation system 122 further includes a second outer layer 134. In the embodiment depicted in FIG. 5, the second outer layer 134 is applied between the nano-composite, intermediate layer 130 and the first outer layer 132. The second outer layer 134 can be manufactured from a polyether ether ketone (PEEK) polymer.

Turning to FIG. 6, shown therein is an embodiment in which the insulation system 122 further includes a protective film layer 136 between the interior layer 128 and the nano-composite, intermediate layer 130. The protective film layer 136 can be manufactured from a polytetrafluoroethylene (PTFE) or polyimide (PI). The protective film layer 136 can have a thickness of between about 0.005 and 0.010 inches. In some embodiments, the protective film layer 136 includes a PTFE film with a thickness of about 0.008 inches.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A multilayered insulation system for insulating a conductor useful in an electric submersible pumping system, the insulation system comprising:
an interior layer surrounding the conductor;
a first outer layer; and
an intermediate layer between the interior layer and the first outer layer, wherein the intermediate layer comprises one or more nanoparticles.

2. The multilayered insulation system of claim 1, wherein the interior layer is fabricated from a metal selected from the group consisting of nickel, tin, zinc, aluminum and lead.

3. The multilayered insulation system of claim 1, wherein the interior layer is fabricated from a ceramic.

4. The multilayered insulation system of claim 1, wherein the interior layer comprises hermetic carbon applied directly to the conductor.

5. The multilayered insulation system of claim 1, wherein the interior layer includes metal-organic framework (MOF) compounds.

6. The multilayered insulation system of claim 1, wherein the intermediate layer comprises a nano-composite layer fabricated from a blend of nanoparticles in a polymer.

7. The multilayered insulation system of claim 6, wherein the nanoparticles comprise graphene.

8. The multilayered insulation system of claim 5, wherein the nanoparticles comprise single walled nanotubes.

9. The multilayered insulation system of claim 5, wherein the nanoparticles comprise carbon black nanoparticles.

10. The multilayered insulation system of claim 5, wherein the polymer is polyether ether ketone (PEEK) and the concentration of nanoparticles in the polymer is between about 0.5% to about 5.0% by weight.

11. The multilayered insulation system of claim 10, wherein the intermediate layer has a thickness of about 0.035 inches.

12. The multilayered insulation system of claim 1, wherein the first outer layer comprises a polymer selected from the group consisting of perfluoro alkoxy alkane (PFA), ethylene propylene rubber (EPR), ethylene propylene diene monomer (EPDM) and mixtures therefore

13. The multilayered insulation system of claim 1, further comprising a second outer layer between the first outer layer and the nano-composite layer intermediate layer.

14. The multilayered insulation system of claim 13, wherein the second outer layer comprises a polyether ether ketone (PEEK) polymer.

15. The multilayered insulation system of claim 1, further comprising a protective film layer between the interior layer and the nano-composite layer intermediate layer.

16. The multilayered insulation system of claim 15, wherein the protective film layer comprises a polytetrafluoroethylene (PTFE) film.

17. The multilayered insulation system of claim 15, wherein the protective film layer comprises a polyimide film.

18. A multilayered insulation system for insulating a conductor useful in an electric submersible pumping system, the insulation system comprising:
an interior layer surrounding the conductor, wherein the interior layer comprises a metal;
a first outer layer, wherein the first outer layer comprises a polymer;
an intermediate layer between the interior layer and the first outer layer, wherein the intermediate layer comprises a nano-composite layer fabricated from a blend of nanoparticles in a polymer; and
a second outer layer between the first outer layer and the nano-composite layer intermediate layer, wherein the second outer layer comprises a polyether ether ketone (PEEK) polymer.

19. A multilayered insulation system for insulating a conductor useful in an electric submersible pumping system, the insulation system comprising:
an interior layer surrounding the conductor, wherein the interior layer comprises a metal;
a first outer layer, wherein the first outer layer comprises a polymer; and
an intermediate layer between the interior layer and the first outer layer, wherein the intermediate layer comprises a nano-composite layer fabricated from a blend of nanoparticles in a polymer;
a second outer layer between the first outer layer and the nano-composite layer intermediate layer, wherein the second outer layer comprises a polyether ether ketone (PEEK) polymer; and
a protective film layer between the interior layer and the nano-composite layer intermediate layer.

20. The multilayered insulation system of claim 19, wherein the protective film layer is selected from the group consisting of polytetrafluoroethylene (PTFE) and polyimide films.
